(19) United States
(12) Patent Application Publication
(10) Pub. No.: US 2007/0106824 A1
(43) Pub. Date: May 10, 2007

(54) Target device in serial communication and external device connected to target device

(76) Inventor: Koichi Hikita, Chiba (JP)

Correspondence Address: KATTEN MUCHIN ROSENMAN LLP, 575 MADISON AVENUE, NEW YORK, NY, 10022-2585, US

(21) Appl. No.: 11/591,185

(22) Filed: Nov. 1, 2006

(30) Foreign Application Priority Data
Nov. 7, 2005 (JP) 2005-321677

(51) Int. Cl. G06F 3/00

(52) U.S. Cl. 710/29

(57) ABSTRACT

A target device for which size reduction is required, and that has a terminal compatible with the series B version, and communicates with an accessory device through a USB connector. The target device includes a universal serial bus (USB) transceiver, and a storage section for holding data to be transmitted through the USB transceiver. The target device sends a flow control signal concerning the transmission of the data held in said storage section to said external device connected thereto through said USB transceiver.

### CROSS-REFERENCE TO RELATED APPLICATIONS

The priority application Number JP 2005-321677 upon which this patent application is based is hereby incorporated by reference.

### BACKGROUND OF THE INVENTION

1. Field of the Invention

The present invention relates to serial communication defined by the USB standard.

2. Related Art

The USB (universal serial bus) standard has been widely used for the serial data transfer standard. In the USB standard, asymmetrical communication is performed between a host and a target. In USB communication, the host takes the initiative in data transfer operation such that a device serving as a host inquires of a target as to whether or not the target has data to be transferred to the host, and if the target has the data to be transferred, the host instructs the target to send the data to the host.

The USB standard prescribes that the receptacle and the connector, which are provided for the host and the target, are different in shape from each other, in order to avoid erroneous connections between the hosts and the targets. To be more exact, a receptacle, called a USB series A receptacle, is used for the host, and a receptacle, called a USB series B receptacle, is used for the target (See Universal Serial Bus Specification, Compaq Computer Corporation, Hewlett-Packard Company, Intel Corporation, Lucent Technologies Inc, Microsoft Corporation, NEC Corporation, and Koninklijke Philips Electronics N.V., 2000).

The USB standard permits a power source to be supplied from the host to the target, but it prohibits the power source being supplied from the target to the host.

Where a portable electronic device, for example, a portable electronic game device, is operated, a case sometimes occurs in which the user wishes to communicate with another electronic device, for example, a personal computer, which is used as the host. Another case also occurs in which the user wishes to connect his or her device to an accessory device, for example, an external microphone, and to communicate with the microphone as the target. The user's wishes will be satisfied if the series A receptacle and the series B receptacle are both provided on the game device. Actually, it is desirable to use only the mini-B type connector under market demand for size reduction, however.

In this circumstance, the portable game device inevitably serves as the target. If the game device communicates with the accessory device according to the USB standard, the accessory device has no choice but to serve as the host. Additionally, the power source must be mounted on the accessory device since the game device cannot supply power to the accessory device.

### SUMMARY OF THE INVENTION

Accordingly, an object of the present invention is to provide a target device for which size reduction is required, and that has a terminal compatible with the series B version, and communicates with the accessory device through the USB connector.

Another object of the present invention is to provide an external device that receives power from the target device for its operation, and is able to communicate with the target device through the USB connector.

According to one aspect of the present invention, there is provided a device system having a target device and an external device. In the device system, the target device and the external device have universal serial bus (USB) transceivers, respectively, and are interconnected to be communicable with each other through the USB transceivers. The target device includes a storage section for holding data to be transmitted through the USB transceiver, and sends a flow control signal concerning the transmission of the data held in the storage section to the external device connected thereto through the USB transceiver. The external device receives the flow control signal concerning the data transmission from the target device connected thereto through the USB transceiver, and controls the transmission operation of data between the external device itself and the external device according to the flow control signal.

### BRIEF DESCRIPTION OF THE DRAWINGS

FIG. 1 is a view showing a block diagram of an information processing system according to an embodiment of the present invention;

FIG. 2 is a perspective view showing a portion, which includes a receptacle, of the housing of a target device in the embodiment;

FIG. 3 is a schematic diagram of an external device in the embodiment;

FIG. 4 is a block diagram showing a configuration of a target device in the embodiment;

FIG. 5 is a block diagram showing a configuration of an external device in an embodiment;

FIG. 6 is a functional diagram showing a configuration of a target device according to an embodiment;

FIG. 7 is a table containing correspondence between logical numbers and physical numbers, which are managed in the target device in the embodiment;

FIG. 8 is a functional diagram showing a configuration of an external device in the embodiment; and

FIG. 9 is a diagram showing an exemplary communication flow in the information processing system according to the embodiment of the present invention.

### DESCRIPTION OF THE PREFERRED EMBODIMENTS

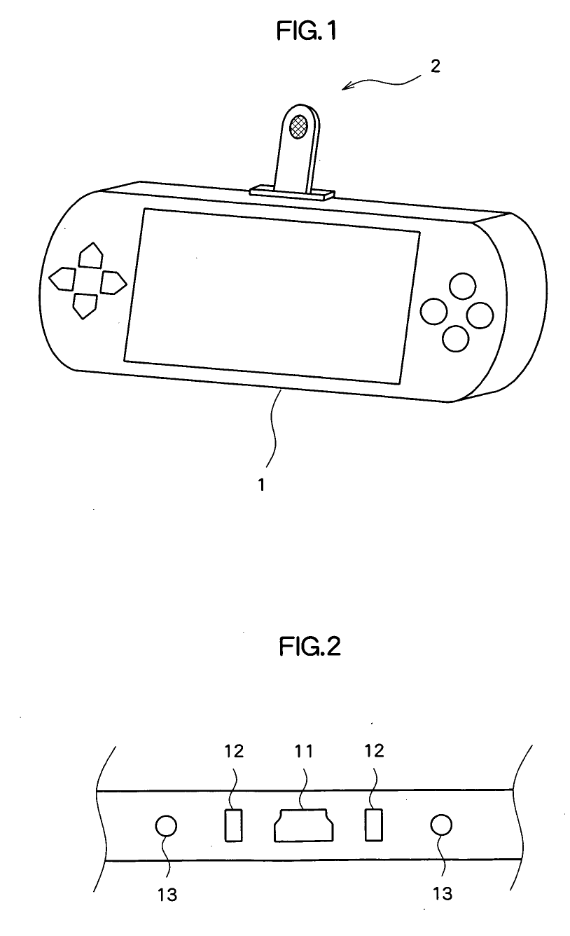

The preferred embodiment of the present invention will be described with reference to the accompanying drawings. A serial communication system according to an embodiment of the present invention, as shown in FIG. 1, generally contains a target device 1 and an external device external device 2.

The target device 1, as shown in FIG. 2, is provided with a USB series B receptacle 11, and power supply terminals 12 adjacent to the receptacle 11. The receptacle 11 is a USB mini-B type receptacle, and the power supply terminals 12 are located on both sides of the receptacle 11. Screw reception sections 13 for fixing the external device 2 are provided on the outer sides of the power supply terminals 12, respectively. FIG. 2 is a perspective view showing a portion, which includes the receptacle 11, of a housing of the target device 1. The target device 1 operates as a normal USB target when the receptacle 11 is connected to a general personal computer (PC), which serves as a host, through the USB series B receptacle 11, by using a general USB cable.

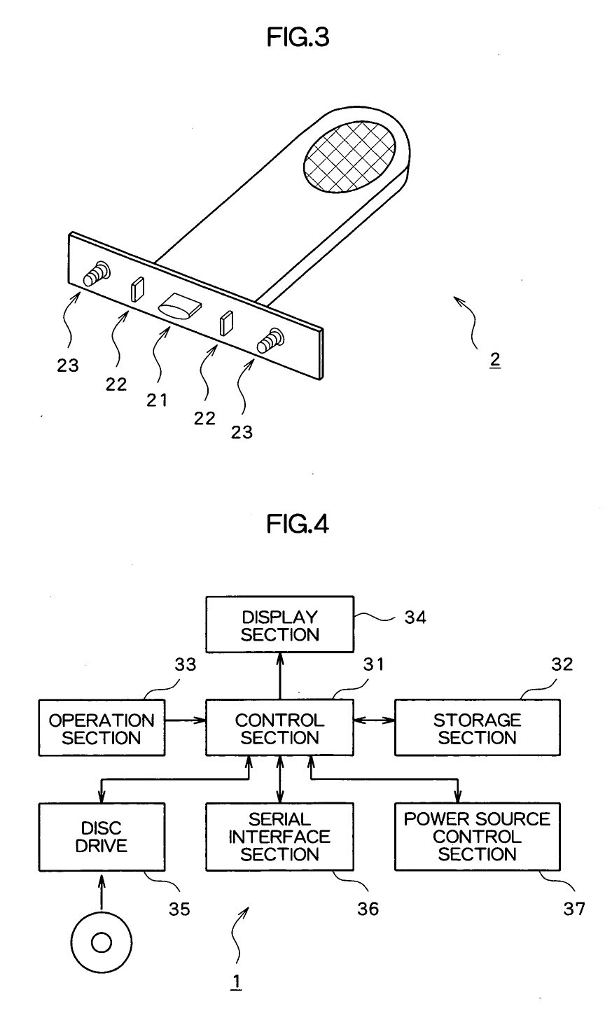

The external device 2 may be a microphone, a camera, a GPS receiver or the like. In this instance, it is a microphone. The external device 2, as shown in FIG. 3, is provided with a USB series B connector 21. Power source connectors 22 are located on both sides of the connector 21. When the connector 21 is inserted into the receptacle 11 of the target device 1, the power source connectors 22 come into contact with the power supply terminals 12, respectively. Further, screws 23 are respectively provided at positions located on the outer sides of the power supply terminals 12. As already stated, in this instance, the microphone, by way of example, is used for the external device 2. The external device 2 is not limited to a microphone as a matter of course.

To connect the external device 2 to the target device 1, the user inserts the connector 21 into the receptacle 11 of the target device 1, and fits screws 23 into the screw reception sections 13, respectively. In addition, the power source connectors 22 come into contact with the power supply terminals 12, respectively.

The target device 1, as shown in FIG. 4, contains a control section 31, a storage section 32, a operation section 33, a display section 34, a disc drive 35, a serial interface section 36, and a power source control section 37.

The control section 31, which is a program-processing device such as a CPU, operates according to a program stored in the storage section 32. In the embodiment under discussion, the control section 31 performs communication with the external device 2, through the serial interface section 36. The details of the processing executed by the control section 31 will be described later.

The storage section 32 includes a storage component, such as RAM, and holds a program to be executed by the control section 31. This program is read out by the disc drive 35 from a disc media, which is set in the disc drive 35, and stored into the storage section 32. The storage section 32 also functions as work memory for the control section 31.

The operation section 33, which includes a button, an analog input device, etc., accepts operations by the user and outputs the operation contents to the control section 31. The display section 34, including a liquid crystal display, etc., displays information according to instructions issued from the control section 31.

The disc drive 35 optically or magnetically reads information from a disc media having information optically or magnetically stored therein, and outputs the read out information to the control section 31. The serial interface section 36, which is an interface device constructed according to the USB standard, operates according to instructions issued from the control section 31. The serial interface section 36 will also be described in detail later.

The power source control section 37 supplies electrical power to related sections. The power source control section 37 also supplies electrical power to the external device 2 by way of the power supply terminals 12, according to instructions issued from the control section 31.

A microphone as one form of the external device 2, as shown in FIG. 5, includes a power source section 41, a communication controller section 42, a microphone section 43, and an A/D converter section 44.

The power source 41 supplies power, received through the power source connectors 22, to the related sections. The communication controller section 42 functions substantially as a USB host. The communication controller section 42 communicates with the target device 1 via the connector 21, and outputs a voice digital signal to the target device 1. The voice digital signal is formed in a manner that the microphone section 43 to be described later gathers voice data and the A/D converter section 44 converts it to the voice digital signal. The details of the communication by the communication controller section 42 will also be described later.

The microphone section 43 converts an incoming voice signal to an electrical signal and outputs the converted electrical signal. The A/D converter section 44 converts the electrical voice signal output from the microphone section 43 to a digital signal, and outputs the converted digital signal.

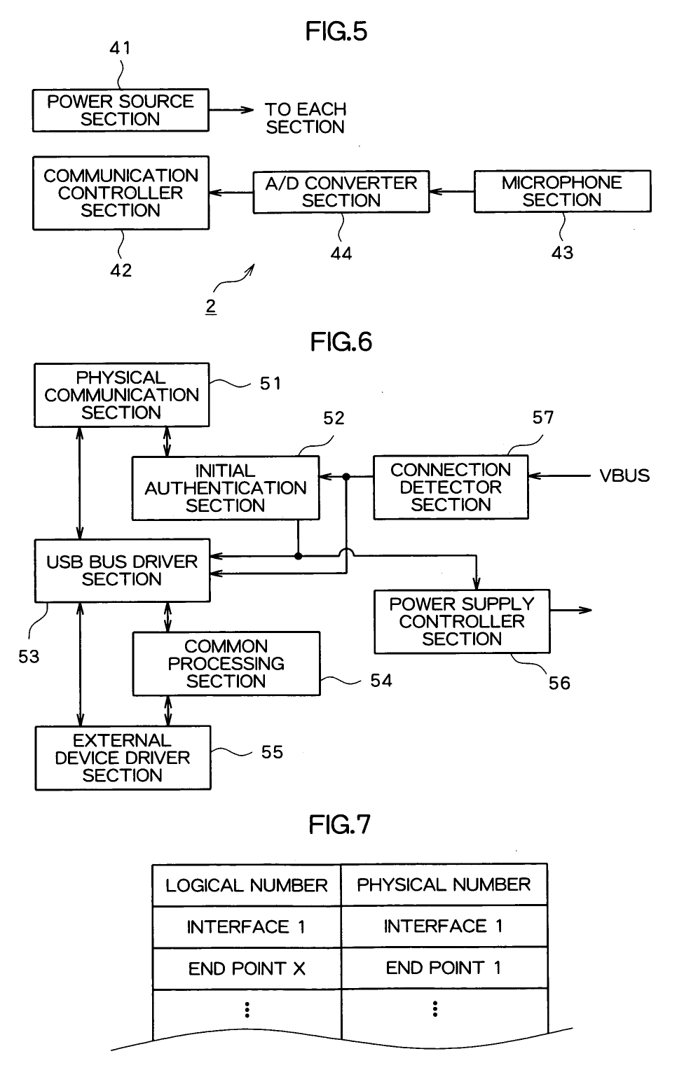

Operation of the target device 1 will be described. The target device 1, as shown in FIG. 6, functionally includes a physical communication section 51, an initial authentication section 52, a USB bus driver section 53, a common processing section 54, an external device driver section 55, a power supply control section 56, and a connection detector section 57.

The physical communication section 51 controls an electrical state of each terminal of the receptacle 11 according to the data to be transmitted, which is received from the USB bus driver section 53, and outputs a signal, which is received through each terminal of the receptacle 11, to the USB bus driver section 53. The physical communication section 51 corresponds to a USB transceiver.

The initial authentication section 52 may be realized in the form of software to be executed by the control section 31. When the connection detector section 57 outputs a signal indicating that it has detected the connection of the external device 2 or the like, then the initial authentication section 52 in response receives out-of-standard certification information through the physical communication section 51. The out-of-standard certification information is used for processing the authentication not prescribed in the USB standard. The initial authentication section 52 performs the authentication process by using the received out-of-standard certification information, and outputs the result of the authentication. The authenticating process is not limited to a specific process. It may be a general method using, for example, a public key. The initial authentication section 52 sends out-of-standard certification information as the information used for the authentication not defined in the USB standard, through the physical communication section 51. The out-of-standard certification information may be the descriptor itself of the external device 2 in the USB standard or data formed when the descriptor is encrypted. It suffices that the initial authentication section 52 performs the authentication based on whether or not at least part of the descriptor of the external device 2, which is received from the external device 2, is coincident with predetermined information.

The USB bus driver section 53 may be installed as USB bus driver software to be executed by the control section 31. The USB bus driver section 53 starts to execute the process when the connection detector section 57 detects connection of the external device 2 or the like. Also, the USB bus driver section 53 receives the information representing a type of the opposite party (external device 2 or the like in this instance), and in response executes the process of the common processing section 54 and the process of the external device driver section 55 corresponding to the type of the opposite party. In other words, a program realizing the common processing section 54 and a program realizing the external device driver section 55 are read into the storage section 32, and a state that allows the control section 31 to execute those programs is set up. Operation of the USB bus driver section 53 will be described in detail later.

The common processing section 54 is realized as a program module which defines a process common to various types of external devices which may be connected to the game device. The common processing section 54 operates through the execution of the program module by the control section 31. The common processing section 54 executes a process for authenticating the external device 2 according to the USB standard, and a process for outputting flow control signals concerning the transmitting/receiving of the data to the external device 2.

The external device driver section 55 is a program module that is provided for each external device 2, and executed by the control section 31. The external device driver section 55, which corresponds to, for example, the external device 2 of the microphone, receives a voice digital signal received by the physical communication section 51, through the USB bus driver section 53, and executes a voice signal process concerning the digital signal and outputs the resultant signals.

The power supply controller section 56 starts to supply power through the power supply terminals 12 after power-on or when the user performs a predetermined operation. When the opposite party to which the target device is connected through the receptacle 11 is not the external device 2, but a general PC serving as a USB host, the control section 31 may stop the power supply. Whether or not the opposite party is the USB host may be detected based on the result of the authentication by the physical communication section 51

The connection detector section 57 detects whether or not some device (external device 2 or the like) is connected to the receptacle 11 depending on whether or not power voltage is applied to a VBUS terminal contained in the receptacle 11. When receiving the power voltage at the VBUS terminal, the connection detector section 57 outputs a signal indicating that some device is connected to the receptacle. When receiving no power voltage at the VBUS terminal, it may output a signal indicating that no device is connected to the receptacle.

Operation of the USB bus driver section 53 will be described hereunder. In the embodiment, at least one external device driver section 55 is plugged into the USB bus driver section 53 to thereby form a driver for controlling the external device 2.

The USB bus driver section 53 receives information indicating that the authentication has completed (authentication has succeeded) from the initial authentication section 52, and assigns a physical interface number and a physical endpoint number to the external device 2 to which the target device is connected through the physical communication section 51. Also, the USB bus driver section 53 receives the information indicating a type of the connected external device 2 from the connected external device 2 itself, and reads the program of the common processing section 54 and the program of the external device driver section 55 corresponding to the external device 2 of that type into the storage section 32, and sets up a state allowing the control section 31 to execute the programs. The program of the external device driver section 55 is designed to transfer data to and from the common processing section 54 and the USB bus driver section 53. Such a program generating method may be a method known as a plug-in program.

The USB bus driver section 53 receives a logical interface number and an endpoint number (those numbers will be referred generally to as logical numbers.) from the external device driver section 55 thus plugged in, and stores the physical interface number and the physical endpoint number (physical numbers), and the logical interface number and the logical endpoint number (logical numbers) in a state where the physical numbers correspond to the logical numbers.

The USB bus driver section 53 receives the logical numbers and the descriptor from the external device driver section 55 for which the plug-in is requested, and stores those pieces of information. Also, the USB bus driver section 53 compares a descriptor of the external device 2 that the initial authentication section 52 has received with the descriptor received here, and generates a table tabulating the physical numbers of the external device 2 and the logical numbers informed from the external device driver section 55 in an associative manner, and stores the table (FIG. 7). As a result, the configuration is completed and a communicable state is set up. The USB bus driver section 53 informs the external device driver section 55 of the communicable state.

A process executed when the USB bus driver section 53 engages in communication with another party will now be described hereunder. The USB bus driver section 53 receives the designation of the endpoint in terms of the logical signal and a transmission request from the external device driver section 55. The USB bus driver section 53 converts the logical number designating the endpoint to the physical number, and queues the information concerning a transmission request received from the external device driver section 55 in a preset endpoint buffer (queue), which is preset for each endpoint designated by the physical number.

The USB bus driver section 53 queues data that is received from the external device 2 with designating the endpoint, in an endpoint buffer corresponding to the designated endpoint. When receiving a readout instruction corresponding to the designated endpoint from the external device driver section 55, the USB bus driver section 53 converts the logical number of the designated endpoint to a physical number, and outputs to the external device driver section 55 the data which is stored in the endpoint buffer corresponding to the endpoint designated by the physical number that is obtained by the conversion.

It is assumed that a logical number “X” and a physical number “1” are assigned to an endpoint (referred to as endpoint A) set for to the external device 2. When the external device driver section 55 sends data to be transmitted to endpoint A of the logical number “X”, the USB bus driver section 53 then receives this request. The USB bus driver section 53 converts the logical number “X” to a physical number “1” corresponding the former, and sequentially holds transmission data in a queue corresponding to the endpoint A of the converted physical number “1”. Further, it holds the to-be-transmitted data in the endpoint buffer designated by endpoint A.

When receiving from the external device 2 an inquiry as to whether or not the transmission data is present at the endpoint A, the USB bus driver section 53 responds to the inquiry and sends the data in the endpoint buffer to the external device 2 of the inquirer according to the queued request for the endpoint A. When completing the data sending, the USB bus driver section 53 informs the corresponding external device driver section 55 of the data sending completion.

The USB bus driver section 53 may receive data destined for the device, in place of the data destined for the interface or the endpoint from the external device 2. In this case, the USB bus driver section 53 outputs the data destined for designated devices to each of corresponding external device driver section 55 for which the interface number or the endpoint number is set.

In this embodiment, the external device driver section 55 uses the logical number, not the physical number, when it request for the opposite party or parties to transmit or receive data. Accordingly, there is no need to execute a process for following the physical number, which may change with every starting/stopping operation of the physical device. This feature makes it easy for a designer to design the external device driver section 55.

When the request completes, when the configuration of the device completes, and when it is transferred to another state, the USB bus driver section 53 send the information to the corresponding external device driver section 55, whereby the external device driver section 55 may take a corresponding action. In this respect, the system versatility is enhanced.

The external device driver section 55 requests the common processing section 54 to execute the processes to be implemented in common, such as the process to authenticate the external device 2 according to the USB standard and the process of outputting flow control signals concerning the transmission/reception of the data to and from the external device. Upon receipt of the request, the common processing section 54 executes necessary processes. Accordingly, the process to be implemented in the external device driver section 55 is simplified, and the program implementation is easy.

The external device driver section 55 in this embodiment executes a process of transferring flow control signals, which concerns the transmission/reception of the data held in the endpoint buffer, to the external device 2. For example, the external device driver section 55 acquires information of the capacity of the endpoint buffer, which is used for the reception from the external device 2, at appropriate, such as periodical timings. When the buffer capacity, represented by the acquired information, is less than a predetermined stop threshold value, the external device driver section 55 instructs the common processing section 54 to issue an instruction to stop the transmission of data in connection with the endpoint.

The common processing section 54 outputs to the USB bus driver section 53 the logical number of the endpoint related, and a control signal indicating that the transmission is to be stopped. The USB bus driver section 53 converts the input logical number to a physical number, and outputs a transmission stop control signal to the external device 2 relating to the physical number.

The external device driver section 55 instructs the common processing section 54 to output an instruction to resume the transmission of the data concerning the endpoint when the capacity of the endpoint buffer used for the reception from the external device 2 exceeds a predetermined threshold value.

The common processing section 54 outputs a logical number of the related endpoint and a control signal to start the transmission of the data. The USB bus driver section 53 converts the input logical number to a physical number, and outputs a control to start the transmission to the external device 2 relating to the physical number.

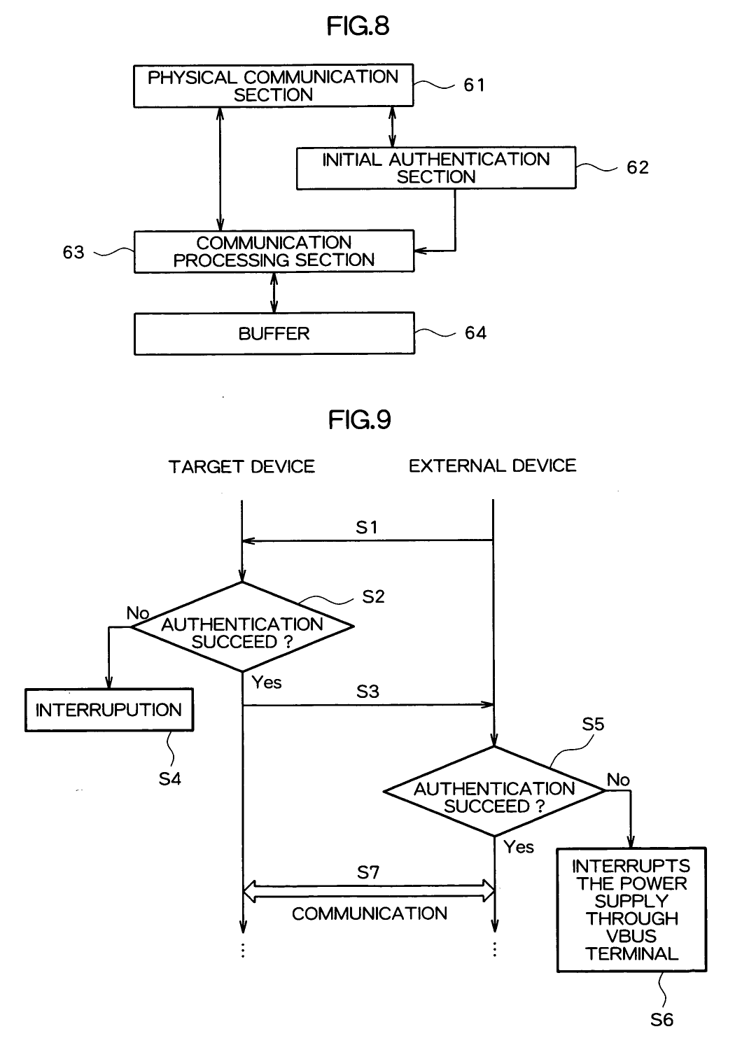

Operation of the communication controller section 42 in the external device 2 connected to the target device 1 will be described. The communication controller section 42, as shown in FIG. 8, is functionally includes a physical communication section 61, an initial authentication section 62, a communication processing section 63, and a buffer 64.

The physical communication section 61 receives data to be transmitted, from the initial authentication section 62 and the communication processing section 63. Also, the physical communication section 61 controls electrical states of the terminals of the connector 21 according to the data to be transmitted, and outputs the signals that are received from the respective terminals of the connector 21, to the initial authentication section 62 and the communication processing section 63.

When supplying of power starts in the power source section 41, the initial authentication section 62 outputs predetermined out-of-standard certification information through the physical communication section 61. The out-of-standard certification information is, for example, a descriptor defined in the USB standard. The initial authentication section 62 supplies, in the initial stage, power supplied form the power source section 41 to the target device 1, through the VBUS terminal contained in the connector 21.

When receiving the out-of-standard certification information from the target device 1, the initial authentication section 62 authenticates the related device by using the out-of-standard certification information, and outputs the result of the authentication. In this instance, the out-of-standard certification information that is received from the target device 1 is a descriptor of the USB standard of the target device 1. The initial authentication section 62 performs the authentication depending on whether or not at least part of the descriptor is coincident with predetermined information.

The out-of-standard certification information, which is transferred to and from the target device 1, is the encrypted descriptors of the USB standard, for example. In this case, a key used for the encoding and decoding may be stored in tamper-proof memory in the target device 1 and the external device 2.

When failing to make the authentication, the initial authentication section 62 stops the supply of power through the VBUS terminal contained in the connector 21.

When the initial authentication section 62 outputs information indicating that the authentication has completed (has succeeded in making the authentication), the communication processing section 63 starts a communication process as in the general USB and then is assigned physical interface number and the endpoint number. In addition, the communication processing section 63 sends the data stored in the buffer 64 to an endpoint buffer having an endpoint number which was allotted by the target device 1. The communication processing section 63 inquires of the target device 1 as to whether or not the device has the data to be transmitted.

As mentioned, in the example of this embodiment, the external device 2 is the microphone. Accordingly, the voice digital signal, which was acquired by the microphone section 43 and underwent the analog-to-digital conversion by the A/D converter section 44, is held in the buffer 64 as to-be-transmitted data. In addition, the communication processing section 63 sends the to-be-transmitted data held in the buffer 64 to the target device 1.

The communication processing section 63 receives a signal indicating that data transmission is to be stopped, from the target device 1, the communication processing section 63 stops the data transmission and stands by for the next processing. When the communication processing section 63, which is in the standby state, receives a signal indicating that the data transmission is to be started, from the target device 1, the communication processing section 63 starts the data transmission to send the to-be-transmitted data having being held in the buffer 64 to the target device 1. Thus, in the embodiment, the external device 2 controls the start/stop of the data transmission according to flow control signals received from the target device 1.

The serial communication system of the present embodiment of the invention performs communication in the following way. The connector 21 of the external device 2 is inserted into the receptacle 11 of the target device 1, the screws 23 are fitted to the screw reception sections 13, and then the power source connector 22 comes in contact with the connector 21.

In turn, power is supplied to the external device 2. In the initial stage, the external device 2 supplies the power to the target device 1 through the VBUS terminal of the connector 21.

Upon the supply of power to the VBUS terminal, the target device 1 detects that it has been connected to the external device 2.

Then, the target device 1 and the external device 2 start to perform a communication process as shown in FIG. 9. As a first step, the external device 2 sends to the target device information of a descriptor based on the USB standard as out-of-standard certification information (S11). As described, the external device 2 is the microphone. Accordingly, information indicative of the microphone and the like are sent. The target device 1 refers to the out-of-standard certification information, and determines whether the vender information, for example, is coincident with predetermined information (S2). If the answer is YES (coincident), the target device 1 recognizes that the authentication succeeds, and sends to the external device 2 the information of the descriptor of the target device 1, based on the USB standard (S3). If the answer to the step S2 is NO, the target device 1 may interrupt the connection process, for example, by stopping the power supply (S4).

When receiving the out-of-standard certification information from the target device 1, the external device 2 determines whether such information as vender information, contained in the out-of-standard certification information, is coincident with predetermined information (S5). If the answer is NO, the external device 2 interrupts the power supply through the VBUS terminal of the connector 21 (S6). When detecting the power supply interruption, the target device 1 recognizes that the connection is removed.

If the answer to the step S5 is YES, the device starts communication based on the USB standard (S7).

After the communication starts, when the target device 1 determines that a condition to restrict the data transmission from the external device 2 is set up, for example, the free capacity of the endpoint buffer is small, the target device 1 sends a signal representing that the data transmission is to be stopped, to the external device 2 corresponding to the endpoint buffer. Upon receipt of this signal, the external device 2 stops the transmission of data. As a result, loading of the data to the endpoint buffer in the condition that the data transmission is to be restricted is stopped.

When the target device 1 determines that with the endpoint buffer in a state where the data transmission to the buffer itself has been stopped, the condition where the data transmission is to be stopped is removed, and the target device 1 outputs a signal representing that the data transmission is to be started, to the external device 2 corresponding to the endpoint buffer. In response to the signal, the external device 2 re-starts the data transmission.

An exemplary flow control for preventing an overflow of the endpoint buffer has been described, but it is clear that the flow control is not limited to this example. In another example, a sync signal in the synchronous communication is transmitted as the flow control signal, and synchronous communication is performed between the target device 1 and the external device 2. In an additional example, in the asynchronous communication, the data start signal and the data stop signal are transmitted as the flow control signals.

Thus, in the present embodiment, in a case where size reduction is required, and the target device having the terminal compatible with the series B version communicates with the accessory device through the USB connector, the target device is able to play a key role in control the stop/restart of communication.

According to the embodiment, it is also enabled to communicate with the target device through the USB connector, while receiving power source from the target device.

While the case has been described in which the external device 2 is a device basically outputting (transmitting) data, such as a microphone, the external device 2 may be a device which receives and processes data such as a MIDI (musical instruments digital interface) device. Further, it may be a device for transmitting and receiving data such as a hard disk device.

Additionally, the external device 2 of the embodiment may be a device having multiple functions such as a microphone with a camera. In this case, the external device 2 sends corresponding information representing kinds of each function.

The USB bus driver section 53 receives the information representing kinds of functions, and reads into the storage section 32 the program of the common processing section 54 and the programs of the external device driver sections 55 corresponding to the input kinds of functions, and sets up a condition where those programs are executable by the control section 31.

The USB bus driver section 53 receives the logical numbers of the external device driver sections 55 thus plugged in, and holds logical numbers in association with the physical numbers.

That is, the USB bus driver section 53 receives the logical numbers and descriptors from the external device driver sections 55 for which the plug-in is requested, and holds these pieces of information. Also, when the descriptor is coincident with the descriptor received by the initial authentication section 52, the USB bus driver section 53 generates a table which associates the physical numbers of the external device 2 with the logical numbers informed from the external device driver section 55 (FIG. 7). As a result, the configuration has completed and a communicable state is set up, and the USB bus driver section 53 informs each external device driver section 55 of the communicable state.

The USB bus driver section 53 accumulates data or the like (request) transmitted, as well as every endpoint buffer in the queue and holds them. The USB bus driver section 53 also allocates (routes) the request data accumulated in the endpoint buffers to the external device driver sections 55 corresponding to the endpoint buffers, and outputs them.

When the data or the like (request) to be transmitted to the external device 2 is received by an application program, the USB bus driver section 53 outputs the request data to all the external device driver sections 55 being plugged in.

When the request is acceptable, the external device driver section 55 instructs the USB bus driver section 53 to send the request to the external device 2.

When the external device 2, for example, a microphone having a camera, is connected, the external device driver sections 55 each corresponding to the device driver for the camera and the device driver of the microphone are plugged into the USB bus driver section 53. In addition, the USB bus driver section 53, which has received an image capture instruction to the camera, outputs the instruction to the external device driver sections 55. At this time, the external device driver section 55 corresponding to the device driver of the microphone does not respond to the image capture instruction. The external device driver section 55 corresponding to the camera device driver responds to the image capture instruction, stores the instruction in the corresponding endpoint buffer, and instructs the USB bus driver section 53 to output the instruction to the external device 2.

According to the instruction, the USB bus driver section 53 sends to the external device 2 the image capture instruction that is stored in the endpoint buffer corresponding to the camera device driver. The camera section of the external device 2 picks up a picture according to the instruction, and outputs image data gathered by the image capture operation. The USB bus driver section 53 receives the image data, and stores it in the endpoint buffer (corresponding to the camera device driver) which reads out the image capture instruction.

The external device driver section 55 corresponding to the camera device driver receives the image data thus obtained by the image capture operation, and transfers the image data to the application program, for example. The image data transfer may be performed in such a manner that the image data is stored in the storage section 32, for example, and then information indicative of the storage position is output to the image capture requester such as the application program.

While the present invention is described in terms of preferred or exemplary embodiments, it is not limited thereto.

What is claimed is:

1. A device system having a target device and at least one external device, wherein said target device and said external device have universal serial bus (USB) transceivers, respectively, and are interconnected so as to be communicable with each other through said USB transceivers, said target device includes a storage section for holding data to be transmitted through said USB transceiver, and sends a flow control signal concerning the transmission of the data held in said storage section to said external device connected thereto through said USB transceiver, and said external device receives said flow control signal concerning the data transmission from said target device connected thereto through said USB transceiver, and controls the transmission operation of data between said external device itself and said external device according to said flow control signal.

2. A target device having a USB transceiver and a storage section holding data being transmitted via USB transceiver, wherein said target device sends a flow control signal concerning the transmission of the data held in said storage section to said external device connected thereto through said USB transceiver.

3. The target device according to claim 2, further comprising a control section for executing a process defined by a bus driver program module for executing control of said USB transceiver, a common processing program module for defining a process common to various types of external devices connected thereto through said USB transceiver, and a proper program module for defining processes proper to said external devices connected thereto through said USB transceiver by communicating with at least one of said common processing program module and said bus driver program module.

4. The target device according to claim 2, wherein before communication based on the USB standard is started, said target device transmits out-of-standard certification information concerning an authentication not prescribed in the USB standard, and applies a predetermined authentication process based on said out-of-standard certification information to an external device connected thereto through said USB transceiver.

5. The target device according to claim 2, wherein said flow control signal is a signal for instructing the start and stop of the transmission of data.

6. An external device having a USB transceiver, wherein said external device receives a flow control signal concerning the transmission of data from a target device connected thereto through said USB transceiver, and controls the transmission operation of data to and from said target device according to said flow control signal.

7. A communication control method in a device system having a target device and an external device in which said target device and said external device have universal serial bus (USB) transceivers, respectively, and are interconnected so as to be communicable with each other through of said USB transceivers, wherein said target device holds data to be transmitted through said USB transceiver, and sends a flow control signal concerning the transmission of the data held to said external device connected thereto through said USB transceiver, and said external device receives said flow control signal concerning the data transmission from said target device connected thereto through said USB transceiver, and controls the transmission operation of data between said external device itself and said external device according to said flow control signal.
